(19) United States
(12) Patent Application Publication
(10) Pub. No.: US 2006/0130343 A1
(43) Pub. Date: Jun. 22, 2006

(54) Hand tool for musical instrument strings

(76) Inventor: Tom Simcoe, Central Point, OR (US)

Correspondence Address: Geoffrey K. Cooper;BIRDWELL & JANKE, LLP, Suite 1400, 1100 SW Sixth Avenue, Portland, OR, 97204, US

(21) Appl. No.: 11/021,124

(22) Filed: Dec. 22, 2004

(51) Int. Cl. B26B 17/00

(52) U.S. Cl. 30/175

(57) ABSTRACT

A hand tool for cutting wire and a method for manufacture. The hand tool comprises a first part having a first jaw, the first jaw having a first recess; a second part having a second jaw and a second insert retention portion; and a first cutting insert disposed in the first recess, the second part being pivotally attached to the first part so that the second insert retention portion covers and holds the first cutting insert in the first recess, so that when the parts are squeezed together the first cutting insert is forced toward the second jaw to cut a wire there between. Preferably the two parts are identical. The method comprises forming the first part and the second part; forming a first recess and a second retention portion respectively therein, placing a cutting insert in the first recess, and affixing both parts to a pivot.

### FIELD OF THE INVENTION

The present invention relates to hand tools useful for cutting musical instrument strings for guitars and other stringed instruments.

### BACKGROUND

Many popular stringed musical instruments currently in use, such as guitars, are strung with wire strings made of steel or other hard metals. Players of such stringed musical instruments often need to replace broken or worn strings at the location of a performance or elsewhere. Replacement wire strings are available commercially, but due to differing dimensions of the various makes of instruments, the wire string must often be cut down to size after installing it on the instrument. Typically, the wire string is provided by the manufacturer in a length sufficient to accommodate the requirements for all of the most common makes of instrument. Thus, it is often necessary for the player who is replacing a string to trim away the extra wire after it is mounted on the instrument, to avoid the aesthetic and safety hazards presented by the extra wire.

The strings of steel-string guitars in particular are formed of hard metal wire that is not readily cut with scissors or other implements suitable for musical instrument strings made of plastic or gut. To safely and effectively cut wire strings of the hardness involved, tools with cutting edges adapted to the purpose are required. Typically, hardened steel or even tougher materials such as carbide are favored for such cutting edges.

There have been tools disclosed that are specifically adapted to cutting the hard wire strings used on musical instruments. U.S. Pat. No. 626,334 discloses a musician's wire cutting device wherein the wire string is threaded through an opening in the device, where it is cut by a cutting head using hand pressure. U.S. Pat. No. 4,872,388 discloses a string anchoring and trimming device that is integral to a musical instrument, being built into the headpiece of a guitar.

Many types of general purpose side cutters or pliers with cutting edges have been disclosed that can be used to cut hard wire strings on guitars and other stringed instruments. More specifically, cutters employing inserts or jaw attachments formed of a material that is harder than the body of the tool are known. Such inserts provide an effective cutting edge with a reasonably long use life, while allowing the rest of the tool to be formed of a more easily worked and less expensive material. U.S. Pat. No. 276,417 discloses pliers with detachable side cutter blades held in sockets on the jaws by shaped shoulders on the blades fitting into recesses in the jaws. U.S. Pat. No. 335,694 discloses pliers wherein cutting edges are provided on face pieces which are held in place on the jaws of the pliers by screws. U.S. Pat. No. 651,082 discloses pliers with removable cutter-jaws, the cutter-jaws being attached to the jaw by a screw that passes through a hole in the cutters and threads into a hole in the jaw. U.S. Pat. No. 6,725,546 discloses a cutting tool using hardened inserts wherein the inserts are held to the jaws of the tool by a screw or a snap, by gluing, or by magnetic attraction. In all of these disclosures, the cutter blades formed of the hardened material typically require fairly extensive shaping to enable their attachment to the pliers' jaws, either the drilling of a hole or the formation of a precision-shaped shoulder to fit a recess. Both types of shaping are relatively difficult to carry out on the very hard and often brittle materials such as tungsten carbide frequently used for cutting inserts, thus adding cost to the final product. When the cutting inserts are held in place by gluing, their replacement is made more difficult as the inserts must be broken or dissolved off for replacement, and magnetic attraction is a relatively weak means of securing the cutting inserts, allowing only a relatively light pressure to be applied.

In light of the foregoing limitations of prior wire cutters, there is a need for a novel approach to the design of cutters that may be used for hard wires such as are used on guitars and other musical instruments.

### SUMMARY

The present invention provides a hand tool generally comprising a first part having a first jaw, the first jaw having a first recess formed therein; a second part having a second jaw and a second insert retention portion; and a first cutting insert disposed in the first recess, the second part being pivotally attached to the first part so that the second insert retention portion covers and holds the first cutting insert in the first recess, so that when the parts are squeezed together the first cutting insert is forced toward the second jaw to cut a wire there between. Preferably, the hand tool further comprises a second part, including a second recess formed therein, the first part further including a first insert retention portion, and a second cutting insert disposed in the second recess so that the first insert retention portion covers and holds the second cutting insert in the second recess, so that when the parts are squeezed together the first cutting insert and the second cutting insert are forced toward one another to cut a wire placed there between.

Preferably, the first part and the second part are substantially identical and are attached to one another by the pivot member so as to form a first class lever. Also, the first part and the second part preferably each include an integral leaf spring for biasing the jaws of the tool open. The cutting inserts preferably comprise hardened material such as carbide. The parts may each be provided with an indentation and a protrusion, the protrusion of one part being disposed within the indentation of the other part and vice-versa so as to limit the distance the first and second parts can rotate away from one another. Further, the tool may include jaw adaptors providing an altered interface between the first jaw and the second jaw.

A method for constructing the hand tool for cutting hard wire musical instrument strings comprises forming a first part having a first jaw portion; forming a second part having a second jaw portion and a second insert retention portion; forming in the first part a first recess for receiving a first cutting insert; placing the first cutting insert in the first recess; and pivotally attaching the second part to the first part so that the second insert retention portion covers and holds the first cutting insert in the first recess, so that when the parts are squeezed together the first cutting insert is forced toward the second jaw to cut a wire there between. Preferably, the method includes forming a first part that further includes a first insert retention portion, forming in the second part a second recess for receiving a second cutting insert, placing the second cutting insert in the second recess, and attaching the second part to the first part so that the first insert retention portion covers and holds the second cutting insert in the second recess, and the second insert retention portion covers and holds the first cutting insert in the first recess, so that when the parts are squeezed together the first cutting insert and the second cutting insert are forced toward one another to cut a wire placed there between. The first part and the second part are formed so as to form respective three-dimensional grips, and may be embossed or reinforced to provide additional strength. The first part and the second part may preferably be formed from sheet metal by cutting and bending, or alternatively may be formed from plastic of suitable strength by any suitable process. The plastic may be reinforced by placement of metal reinforcements within the plastic during the forming operations.

It is to be understood that this summary is provided as a means of generally determining what follows in the drawings and detailed description of the invention and is not intended to limit the scope of the invention. Moreover, the objects, features and advantages of the invention will be more fully understood upon consideration of the following detailed description of the invention taken in conjunction with the accompanying drawings.

### DESCRIPTION OF THE DRAWINGS

FIG. 1 shows a side view of a preferred embodiment of a hand tool for cutting musical instrument strings according to the present invention.

FIG. 2 shows a top view of a preferred embodiment of the hand tool of FIG. 1.

FIG. 3 is a cross-section along line 3-3 of FIG. 1, showing the cutting inserts held in their respective recesses in closed position in a preferred embodiment according to the present invention.

FIG. 4 is a cross-section along line 3-3 of FIG. 1, but modified to show the cutting inserts held in their respective recesses in closed position in a second preferred embodiment according to the present invention.

FIG. 5 is a cross-section along line 3-3 of FIG. 1, but modified to show the cutting inserts held in their respective recesses in closed position in a third preferred embodiment according to the present invention.

FIG. 6 shows a side view of one part of a hand tool according to the present invention.

FIG. 7 shows a top view of the one part of the hand tool of FIG. 6.

FIG. 8 shows a view of a piece of sheet metal cut but unbent in a preferred embodiment of the process of making one part of a hand tool for cutting musical instrument strings according to the present invention.

FIG. 9 shows a side view of one part of a hand tool according to the present invention with a jaw tip extender in place.

FIG. 10 shows a perspective view of a jaw tip extender according to the present invention.

FIG. 11 shows an end view of the jaw tip extender of FIG. 10.

FIG. 12 shows a side view of a preferred embodiment according to the present invention with accessory tool features installed thereon.

FIG. 13 is a top view of the preferred embodiment of FIG. 12.

### DETAILED DESCRIPTION OF PREFERRED EMBODIMENTS

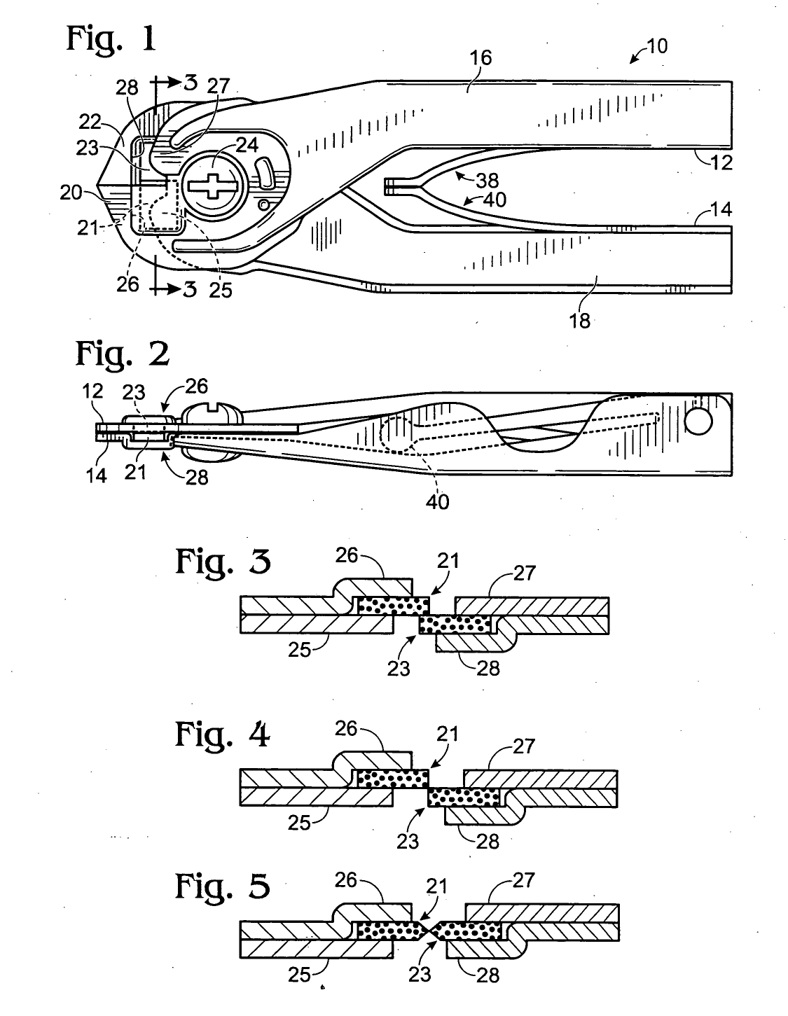

Referring to FIG. 1, a preferred embodiment of a hand tool 10 according to the present invention is shown. Two parts 12 and 14 of the hand tool, comprising respectively handles 16 and 18 and jaws 20 and 22, are attached by a pivot member 24. Preferably, the two parts are identical in form, but they may take forms distinct from each other without departing from the principles of the present invention. The two parts further comprise respective recesses 26 and 28 for receiving cutting inserts 21 and 23, and respective insert retention portions 27 and 25. Each insert retention portion holds in cutting position a respective cutting insert disposed in the recess on the opposing part while the two parts move over their normal range of relative motion when cutting wire. The cutting inserts, and thus the recesses that hold them, are shaped and disposed such that when the jaws are closed, the adjacent edges of the inserts are in contact with each other. The inserts may occupy greater or lesser portions of the jaws from the pivot to the tips of the jaws.

While the cutting inserts 21 and 23 and the recesses 26 and 28 that contain them are preferably rectangular or square in shape, it is understood that they may be of a wide variety of different shapes without departing from the principles of the present invention. For example, the inserts may take the form of half circles, triangles, or other polygonal or even irregular shapes. Preferably, the edges of the inserts that perform the cutting operation are straight, such that the edges of the two inserts meet over a significant length upon closing the handles, but the edges that perform the cutting operation may take other shapes without departing from the principles of the present invention. For example, the cutting edges may be semi-circular in shape. In this case, preferably one insert is concave and one insert is convex, but of equal curvatures, so again the cutting edges meet uniformly over a significant length. Thus, the shapes of the two inserts may differ from each other without departing from the principles of the invention. Also, the cutting edges may meet only over a relatively short length without departing from the principles of the invention.

The inserts may be adapted such that more than one edge may function as a cutting edge. For example, rectangular inserts may have two opposing faces, both of which are suitable as cutting edges, which may be interchanged by reversing the orientation of the cutting inserts in the recesses of the jaws, thus providing fresh cutting edges. Similarly, square inserts may provide four edges suitable for cutting, equilateral triangular inserts may provide three edges suitable for cutting, and so forth. This serves to prolong the life of the cutting inserts, as when one set of cutting edges becomes nicked, worn or otherwise unusable, altering the orientation of the inserts in their respective recesses allows a fresh edge to be used in the cutting operation, a cost savings for the user who does not have to replace the inserts as frequently.

It is further understood that the tips of the jaws 20 and 22 may assume various configurations, for example to facilitate gripping of the wires for holding them or pulling them tight such as through holes in the string pegs of a guitar. The tips of the jaws preferably meet when the two parts are squeezed to a closed position, and thus may be used to grip and hold the hard wire strings.

The handles 16 and 18 may likewise be of a variety of shapes without departing from the principles of the invention. They make be flat, or round in cross-section, or any other shape that provides sufficient strength to transmit the pressure applied to them by the user's hand to the jaws and the cutting inserts. Preferably, one part comprising a handle and a jaw is formed of a single continuous piece of a suitable material such as metal or plastic, but the handle and the jaw may be formed separately and attached to each other by any suitable means without departing from the principles of the invention.

In FIG. 2, a top view of the assembled tool is provided. The top of one handle preferably comprises a leaf spring 40 which has a counterpart 38 on the corresponding handle. This view also further shows the spatial relationship between the cutting inserts 21 and 23 held within recesses 26 and 28 on parts 12 and 14 of this preferred embodiment. Each cutting insert is mounted within the recess in a respective part such that when the jaws 20 and 22 are brought together, the inner sides of the two cutting inserts come into sufficiently close proximity to each other to cut a wire placed between them. In this preferred embodiment, each insert has a thickness substantially equal to the depth of its corresponding recess, so that closure of the jaws results in the inner sides touching or very nearly touching each other. The inserts 21 and 23 are thus laterally offset from each other in this preferred embodiment, each in its respective recess, such that the inner faces only are substantially in adjacent planes very close to one another. In this configuration, the cutting inserts cut the wire by a shearing action. Within this constraint, the thickness of the inserts, and the depths of the recesses that hold them, may vary from tool to tool, depending on variables such as the required strength of the inserts, or the different possible types and specifications of the materials from which the inserts are made.

FIGS. 3 and 4 are cross-sections showing details of the contact regions of the two cutting inserts when the parts of the tool are in the closed position in alternative preferred embodiments cutting by shearing action according to the present invention. The two inserts are laterally offset from each other, such that only portions of the inner faces come in contact with each other, either with little to no overlap as in FIG. 3, or with some degree of overlap as in FIG. 4. As the jaws are closed, shearing action is exerted on the wire placed between them as the cutting inserts approach each other.

The inserts are held in place in their respective recesses by pressure from the insert retention portions 25 and 27 disposed on the opposing part. The insert retention portions 25 and 27 are adapted to firmly contact the inserts 21 and 23 respectively, the insert retention portion of each part securing the insert held within the recess of the jaw of the opposing part by exerting pressure on the face of the insert opposite that face of the insert disposed against the rear of its recess. As the jaws are closed against a wire held therebetween, the insert retention portions and the rear of the recess act to retain the insert from lateral displacement under the closing pressure, thus constraining them to exert the desired cutting force against the wire. The degree of tension with which the inserts are held in place is preferably controllable by the tension with which the two parts 12 and 14 are held to each other by the pivot, for instance when the pivot is a screw and threaded post which may be tightened to various degrees, optionally with a tensioning spring member such as a split washer (not shown). The insert retention portions may preferably be flat where they contact their respective cutting inserts, but alternatively they may have slightly raised sections, such as dimples, that define the regions of contact between the insert retention portions and the respective cutting inserts they retain in the respective recesses without departing from the principles of the invention. Preferably the inserts are held firmly, but not so tightly as to bind the jaws and make them difficult to operate. Preferably the contact surfaces of the retention portions and the inserts are smooth enough to allow for relatively low friction between them as the jaws are opened and closed, despite the pressure exerted on the inserts by the insert retention portions which serves to hold the inserts in their respective recesses.

In another preferred embodiment, the cutting inserts are configured to cut the wire with a pinching action. In this preferred embodiment, illustrated in FIG. 5, the cutting inserts are of sufficient thickness and are located in the jaws such that the upper edges meet face to face when the parts are squeezed. Preferably, the upper edges are both of a sharpened configuration and are disposed such that two sharp edges meet in a directly opposed manner upon closing the parts. Again, the inserts are held by the insert retention portions which are suitably positioned to provide the appropriate amount of pressure to retain the inserts and inhibit lateral displacement under pressure. The cross-sectional view of the details of the cutting insert contact region as shown in FIG. 5 in this preferred embodiment, wherein the inserts are brought to points on the cutting edges, and the points of the two inserts meet directly to cut with the pinching action, further clarify the features of this alternative preferred embodiment.

Preferably, both parts 12 and 14 of the hand tool are provided with respective leaf springs 38 and 40 (FIG. 1) for biasing the two parts of the tool open. The leaf springs, which are preferably integral to the parts, each bear on portions of the opposing part such that when the parts are squeezed and the jaws close, tension is created that biases the parts toward the open position. However, a single leaf spring only may be employed without departing from the principles of the present invention. Preferably, the tip portions of the two leaf springs bear upon each other to create the tension biasing the handles and jaws towards the open position. The tension increases as the handles are squeezed towards the closed position, such that when the wire cutting operation is complete and the squeezing is relaxed, the tension relaxes as the leaf springs return the jaws to the open position to facilitate inserting another section of wire for cutting, if desired. Preferably, the bearing surfaces of the leaf spring tips are suitably shaped and textured such as to provide for smooth operation during the opening and closing of the handles, and are further adapted such that any tendency toward lateral displacement during motion is suppressed and the tips remain firmly opposed to each other to maintain tension on the leaf springs as the tool is used repeatedly.

When the cutting operation is completed and the squeezing pressure is relaxed, the jaws return to an open position due to the biasing pressure exerted by the leaf spring or springs. When the parts are formed from sheet metal by cutting and bending operations, the leaf springs are preferably formed in the same operations. When the parts are formed largely from plastic, the leaf springs may either be formed from a plastic of suitable resiliency, or may be formed from metal embedded in the plastic during or after the forming operations.

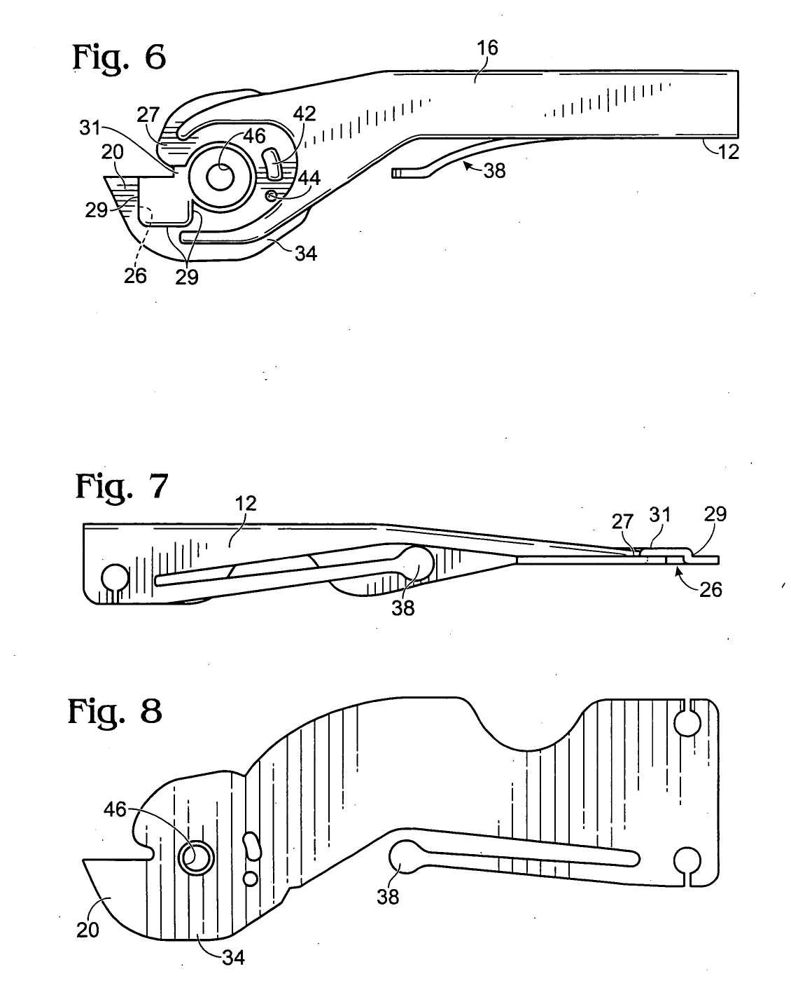

A preferred configuration of a single part 12 is shown by FIGS. 6 and 7. The one part 12 includes the handle 16 and jaw 20, including recess 26 for receiving the insert, and the insert retention portion 27 that will serve to retain the insert on the opposing part 14 in the assembled tool. The recess has walls 29 along three sides, and a partial wall 31 along the cutting portion of the jaw. The partial wall leaves most of the cutting edge of the insert exposed for receiving and cutting a wire, while preventing the insert from slipping laterally out of the recess and further preventing the wire being cut from slipping inwardly past the cutting edges. Further provided is an opening 46, which is adapted to accommodate the pivot member 24 when the tool is assembled. Preferably, each part is further provided with an indentation 42 and a protrusion 44 that, in conjunction with similar features on the opposing part in the fully assembled tool, serve to limit the extent that the tool opens. In addition to keeping the tool compact, this ensures that the inserts cannot be released from their respective recesses without removing the pivot member and separating the two parts.

The leaf spring 38 is provided to bias the assembled parts in an open position. Acting in conjunction with the indentations and protrusions in the assembled tool, the two leaf springs 38 and 40 bias the assembled tool to remain open to the limit permitted by the indentations and protrusions, unless compressed by the user's hand. Preferably the tips of the two leaf springs bear upon each other to some extent even at the fully open position of the two parts as constrained by the indentations and protrusions, such that a certain amount of tension is present as a result of the leaf springs even when the jaws of the tool are fully open. However the leaf springs may bear on other portions of the opposing part without departing from the principles of the invention.

A reinforcing portion 34 provides added strength to the jaw such that pressure may be applied in closing the jaws of the assembled tool without causing substantial bending or distortion. Preferably, the reinforcing portion is embossed to provide additional strength.

Referring to FIG. 8, a cut but un-bent blank of a preferred embodiment formed from sheet metal of part 12 with jaw 20, reinforcing portion 34, opening 46 and leaf spring 38 is shown. This embodiment of part 12 is readily and inexpensively obtained from a sheet of metal of appropriate composition and thickness employing a preferred embodiment of a method of manufacture. In a preferred embodiment of a process for manufacture of the tool 10 from metal, further bending of the blank serves to produce the finished part as shown in FIG. 6, which is then assembled by placing the inserts in their respective recesses and mounting the two parts by the pivot member 24. Preferably, the pivot member comprises a screw and post combination, though other appropriate pivot member designs could be used without departing from the principles of the invention. Preferably, the pivot member is formed from metal, although the metal may be coated with a plastic to reduce friction.

Alternatively, the two parts 12 and 14 may be formed from plastic of sufficient strength by any suitable process, and the parts may also be further reinforced by the emplacement of metal reinforcing elements during the plastic casting or molding operation. In this preferred embodiment, the plastic parts are formed in their final shapes during the molding operation, and no bending is needed as in the embodiment of the processing that comprises forming from metal, to provide the parts with their final shapes. As the cutting operation is preferably performed only by the cutting inserts, no other portion of the jaws need be sufficiently hardened to cut wire. Similarly, the pivot member may be formed entirely from a synthetic material of suitable strength without departing from the principles of the invention.

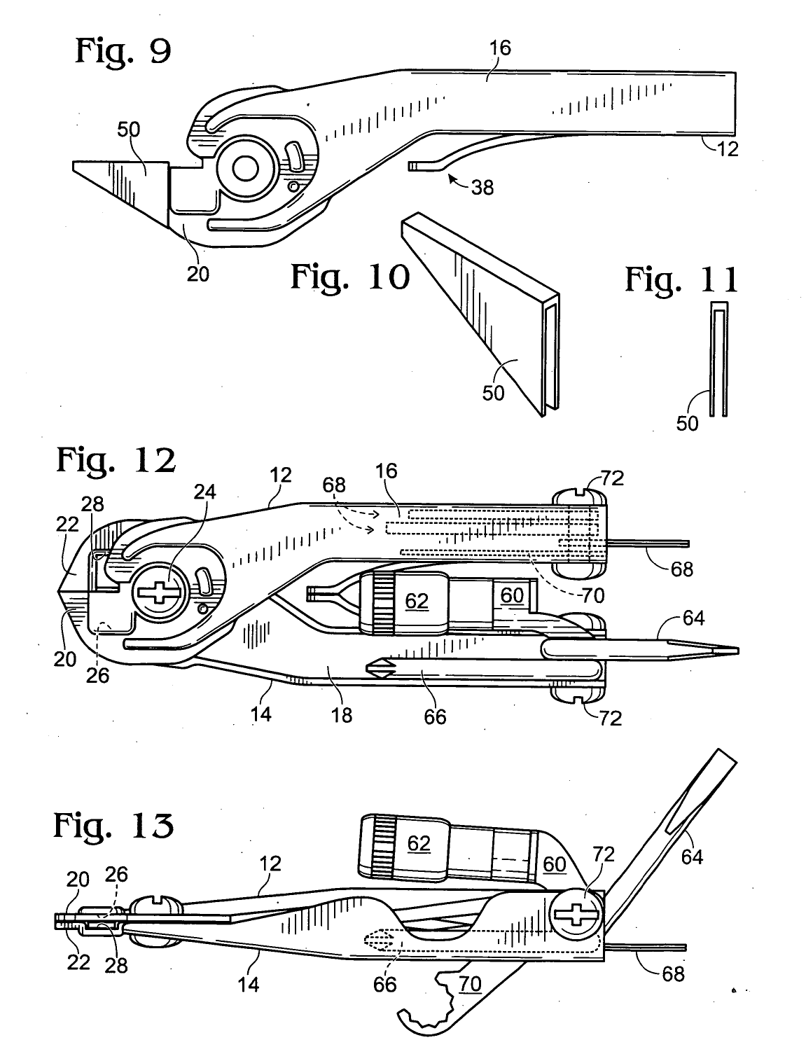

In yet another preferred embodiment, the tips of jaws 20 and 22 may be adapted for additional functions by the placement of tip extensions thereon. Referring to FIG. 9, tip extensions 50 alter the configuration of the jaw tips that are integral to the tool, allowing for different uses of the tool. For example, elongated tips as shown in FIGS. 10 and 11, comprising pieces that fit over the ends of jaws 20 and 22, serve to adapt the tool to function as needle-nose pliers for picking up and holding small parts. Preferably, tip extensions 50 comprise pieces formed from metal or plastic or other suitable materials with a U-shaped cross section that fit tightly over the jaw tips, holding the tip extensions in place during handling and use of the tool. The tip extensions may be provided in a wide range of shapes and sizes, and, while a pressure fit preferably serves to hold the tips in place, other means of fastening do not deviate from the principles of the invention.

Referring to FIGS. 12 and 13, a hand tool according to the present invention may preferably be further provided with tools and other accessory features to add to the utility of the device. For example, a holder 60 may secure a miniature flashlight 62, such as a light-emitting-diode flashlight which may be provided to emit white light or various different colors of light. The flashlight is preferably oriented to illuminate the work area near the jaws and cutting inserts. The holder may be spring-loaded for ready removal of the flashlight when not needed. Also, accessory tools such as screwdrivers with standard 64 and Phillips 66 tips, Allen wrenches 68, open end wrenches including input wrenches 70, such as those adapted to turn 12-point star nuts and the like may be provided. Preferably these tools are disposed at the distal end of the handles 16 and 18 on pivot bars 72 such that each tool is nestled within the handle when not in use, thereby providing protection for the tools and for the user, and may be individually swiveled into position away from the handle for use. Other tools and accessory features may be similarly provided without departing from the principles of the invention.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A hand tool for cutting wire, comprising:
a first part having a first jaw, said first jaw having a first recess formed therein;
a second part having a second jaw and a second insert retention portion;
a first cutting insert disposed in said first recess, said second part being pivotally attached to said first part so that said second insert retention portion covers and holds said first cutting insert in said first recess, and so that when said first part and said second part are squeezed together said first cutting insert is forced toward said second jaw to cut a wire there between.

2. The hand tool of claim 1, wherein said second part includes a second recess formed therein, said first part includes a first insert retention portion, and said tool further comprises a second cutting insert disposed in said second recess so that said first insert retention portion covers and holds said second cutting insert in said second recess, and so that when said first part and said second part are squeezed together said first cutting insert and said second cutting insert are forced toward one another to cut a wire placed there between.

3. The hand tool of claim 2, wherein said second part is pivotally attached to said first part so as to form a first class lever.

4. The hand tool of claim 2, wherein said first part and said second part are substantially identical.

5. The hand tool of claim 4, wherein said second part is pivotally attached to said first part so as to form a first class lever.

6. The hand tool of claim 2, wherein said first part and said second part are formed, at least in part, from sheet metal by cutting and bending.

7. The hand tool of claim 2, wherein said first part and said second part are formed, at least in part, from plastic.

8. The hand tool of claim 6, wherein said first part and said second part each include an integral leaf spring for biasing said first jaw and said second jaw apart.

9. The hand tool of claim 8, wherein said first part and said second part are substantially identical.

10. The hand tool of claim 7, wherein said first part and said second part are substantially identical.

11. The hand tool of claim 9, wherein said second part is pivotally attached to said first part so as to form a first class lever.

12. The hand tool of claim 2, wherein said cutting inserts comprise hardened material.

13. The hand tool of claim 12, wherein said hardened material comprises carbide.

14. The hand tool of claim 13, wherein said cutting inserts are substantially rectangular and relatively thin in comparison to their rectangular edges.

15. The hand tool of claim 14, wherein at least one edge of each cutting insert is machined to form a cutting edge.

16. The hand tool of claim 12, wherein said cutting inserts are substantially rectangular and relatively thin in comparison to their rectangular edges.

17. The hand tool of claim 16, wherein at least one edge of each cutting insert is machined to form a cutting edge.

18. The hand tool of claim 17, wherein said second part is pivotally attached to said first part so as to form a first class lever.

19. The hand tool of claim 18, wherein said first part and said second part each include an integral leaf spring for biasing said first jaw and said second jaw apart.

20. The hand tool of claim 19, wherein said first part further comprises a first indentation and a first protrusion, and said second part further comprises a second indentation and a second protrusion, said first protrusion being disposed within said second indentation and said second protrusion being disposed within said first indentation so as to limit the distance the first and second parts can rotate away from one another.

21. The hand tool of claim 20, wherein said first part and said second part are substantially identical.

22. The hand tool of claim 1, wherein said second part is pivotally attached to said first part so as to form a first class lever.

23. The hand tool of claim 22, wherein said first part and said second part are formed, at least in part, from sheet metal by cutting and bending.

24. The hand tool of claim 22, wherein said first part and said second part are formed, at least in part, from plastic.

25. The hand tool of claim 1, wherein at least one of said first part and said second part includes an integral leaf spring for biasing said first jaw and said second jaw apart.

26. The hand tool of claim 25, wherein said second part is pivotally attached to said first part so as to form a first class lever.

27. The hand tool of claim 1, wherein said first cutting insert comprises hardened material.

28. The hand tool of claim 27, wherein said hardened material comprises carbide.

29. The hand tool of claim 28, wherein said first cutting insert is substantially rectangular and relatively thin in comparison to its rectangular edges.

30. The hand tool of claim 29, wherein at least one edge of said first cutting insert is machined to form a cutting edge.

31. The hand tool of claim 27, wherein said cutting insert is substantially rectangular and relatively thin in comparison to its rectangular edges.

32. The hand tool of claim 31, wherein at least one edge of said first cutting insert is machined to form a cutting edge.

33. The hand tool of claim 27, wherein said second part is pivotally attached to said first part so as to form a first class lever.

34. The hand tool of claim 33, wherein at least one of said first part and said second part includes an integral leaf spring for biasing said first jaw and said second jaw apart.

35. The hand tool of claim 34, wherein said first part further comprises a first indentation and a first protrusion, and said second part further comprises a second indentation and a second protrusion, said first protrusion being disposed within said second indentation and said second protrusion being disposed within said first indentation so as to limit the distance the first and second parts can rotate away from one another.

36. The hand tool of claim 1, wherein said second insert retention portion comprises a flange opposing said first jaw.

37. The hand tool of claim 2, wherein said first insert retention portion comprises a flange opposing said second jaw.

38. The hand tool of claim 1, wherein said first part further comprises a first indentation and a first protrusion, and said second part further comprises a second indentation and a second protrusion, said first protrusion being disposed within said second indentation and said second protrusion being disposed within said first indentation so as to limit the distance the first and second parts can rotate away from one another.

39. The hand tool of claim 1, wherein said first part and said second part are made of stainless steel.

40. The hand tool of claim 1, further comprising a first jaw adaptor and a second jaw adaptor for attachment to said first jaw and said second jaw, respectively, said first and second jaw adaptors providing an altered interface between said first jaw and said second jaw.

41. The hand tool of claim 40, wherein said jaw adaptors include a u-shaped portion for friction engagement with their respective jaws.

42. The hand tool of claim 15, wherein said first part and said second part are substantially identical, wherein said second part is pivotally attached to said first part so as to form a first class lever, wherein said insert retention portions comprises respective flanges, and wherein at least one of said first part and said second part includes an integral leaf spring for biasing said first jaw and said second jaw apart; said first part further comprising a first indentation and a first protrusion and said second part further comprising a second indentation and a second protrusion, said first protrusion being disposed within said second indentation and said second protrusion being disposed within said first indentation so as to limit the distance the first and second parts can rotate away from one another.

43. The hand tool of claim 42, wherein said first part and said second part are formed, at least in part, from sheet metal by cutting and bending.

44. The hand tool of claim 42, wherein said first part and said second part are formed, at least in part, from plastic.

45. The hand tool of claim 1, wherein said first recess forms a plurality of walls for constraining lateral movement of said first cutting insert, one said wall extending only partially along an edge of said insert so as to allow a wire to be cut by said edge.

46. A method for constructing a hand tool for cutting wire, comprising:
forming a first part having a first jaw portion;
forming a second part having a second jaw portion and a second insert retention portion;
forming in said first part a first recess for receiving a first cutting insert;
placing said first cutting insert in said first recess; and
pivotally attaching said second part to said first part so that said second insert retention portion covers and holds said first cutting insert in said first recess, and so that when said parts are squeezed together said first cutting insert is forced toward said second jaw to cut a wire there between.

47. The method of claim 46, wherein said forming said first part includes forming a shape that includes a first insert retention portion, said method further includes forming in said second part a second recess for receiving a second cutting insert, placing said second cutting insert in said second recess, and said pivotally attaching includes attaching said second part to said first part so that said first insert retention portion covers and holds said second cutting insert in said second recess, and so that when said parts are squeezed together said first cutting insert and said second cutting insert are forced toward one another to cut a wire placed there between.

48. The method of claim 46, further comprising forming in said first part a first indentation and a first protrusion and in said second part a second indentation and a second protrusion, so that upon attachment of said second part to said first part said first protrusion is disposed within said second indentation and said second protrusion is disposed within said first indentation so as to limit the distance the first and second parts can rotate away from one another.

49. The method of claim 46, wherein said step of forming comprises cutting from sheet metal.

50. The method of claim 49, further comprising bending said first part and said second part so as to form respective three-dimensional grips.

51. The method of claim 49, wherein in at least one of said cutting a first part and cutting a second part includes cutting a shape having a leaf-spring portion.

52. The method of claim 51, further comprising bending said leaf-spring portion so as to face the opposing part.

53. The method of claim 46, further comprising forming said first cutting insert from a hardened material.

54. The method of claim 53, further comprising forming said first cutting insert from carbide.

55. The method of claim 54, further comprising machining a cutting edge on said first cutting insert.

56. The method of claim 49, wherein said cutting of said first part from sheet metal and said cutting of said second part form sheet metal both include cutting said parts from stainless steel.

57. The method of claim 49, further comprising bending said first part and said second part so as to form handles opposite their respective jaw portions.

58. The method of claim 46, wherein said step of forming comprises forming from plastic.

59. The method of claim 58, wherein said step of forming from plastic further comprises placing metal reinforcements in the plastic.
